(19) United States
(12) Patent Application Publication
(10) Pub. No.: US 2011/0004656 A1
(43) Pub. Date: Jan. 6, 2011

(54) LOAD ASSIGNMENT CONTROL METHOD AND LOAD DISTRIBUTION SYSTEM

(75) Inventors: Chihiro EGASHIRA, Hadano (JP); Satoshi OGUNI, Yokohama (JP); Yasuhiro KAMEDA, Hadano (JP); Hirofumi FUJITA, Kawasaki (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/826,208

(22) Filed: Jun. 29, 2010

(30) Foreign Application Priority Data
Jul. 2, 2009 (JP) 2009-157717

(51) Int. Cl. G06F 15/16

(52) U.S. Cl. 709/203; 709/224

(57) ABSTRACT

A load distribution system including an information table having information about a plurality of servers, a threshold holder having a threshold with respect to a processing state of requests to maintain service level of the plurality of servers, a server manager for monitoring and managing operational states of the plurality of servers, a transmission destination determiner for assigning the requests to a server having a higher priority until the processing state of the server reaches the threshold and after that assigning the requests to the server having a next higher priority; and a power controller for controlling powers of the plurality of servers according to processing states of the plurality of servers for the requests.

### INCORPORATION BY REFERENCE

The present application claims priority from Japanese application JP 2009-157717 filed on Jul. 2, 2009, the content of which is hereby incorporated by reference into this application.

### BACKGROUND OF THE INVENTION

The present invention relates to a load distribution system in an information processing system or the like and more particularly, to a method of suppress the number of operating servers in the information processing system and attaining power saving by providing a load concentration function and positive and suitable concentration of a load quantity.

In an information processing system, in these years, a client PC (personal computer) can be connected to the Internet or to a server via a LAN (local area network) to attain or provide various information or to receive various sorts of services including information search or article sales. Such a system is generally called a web server system.

Such a system can cope with a large number of accesses by distributing access requests from clients (usually personal computers in many cases) to a plurality of servers for the purpose of coping with such a large number of accesses from the clients and of maintaining a high fault tolerance. Even when some of the servers become faulty, the system is arranged so as to avoid service stoppage in the entire system by distributing requests to the other normal servers. An apparatus for performing such processing operation is known as a load distributor.

Such a load distributor has loads distribution function of equally distributing a load including the number of connected clients and a processing quantity (which load will be referred to merely as load) to servers included in the system according to a load distribution algorithm.

Meanwhile, there has been a growing interest in attacking environmental issues including global warming and power saving has also been demanded even in the server system market. This has led to active development of techniques for providing a power saving function.

The aforementioned load distribution system in the conventional load distributor has an advantage that, even when each server has not a high performance, a plurality of servers are used to distribute many accesses from a number of clients equally thereto for processing. However, in such a web server system, it is generally known that a load of accesses from clients varies largely with, for example, a time zone in one day or with a season. In spite of this fact, in order to maintain a constant service quality (response time, ensured upper limit of an allowable access number, etc.), it is required to operate many servers in case of a maximum load. However, this also involves the operation of unnecessarily many servers as when the load level is low. From the viewpoint of power saving, such a technique as to suitably increase or decrease the number of servers in operation is required.

One of prior art techniques for solving the above problems is disclosed in US2003/0225904A1, kanno, et al. (Patent Document 1).

The technique disclosed in Patent Document 1 is to distribute a client request preferentially to a server having a shortest operational time. In the technique, in addition, the quantity of data request from clients is compared with the allowable data supply quantity of the server system, and only ones of the servers required as a necessary minimum number of servers in the entire server system are operated.

In the prior art techniques including Patent Document 1, the load distribution method employs a conventional load distribution system, loads are distributed to a plurality of servers, and the number of ones of the servers in operation is increased or decreased while the load level of the server system at the then time point is measured. When there is a server having no load during operation of the system, the server is stopped. And when the processing capacity of the server system in operation becomes short, a server is newly operated.

### SUMMARY OF THE INVENTION

When compared with the prior art load distributor, the method disclosed in Patent Document 1 can suppress a power consumption. In this method, however, when one of servers not used is present during the load distribution, only such control (which will be referred to as static control, hereinafter) as to turn off the power of the server not used, to gradually reduce the number of assigned or allocated servers in this manner and to waits for occurrence of a load concentration as a matter of course, can be carried out.

In the static control, since load allocation destination servers are determined with use of the load level of the server system when each server returns request data to clients before a time point of occurrence of a load, a time lag occurs in setting between an actual loads count and a servers count. For this reason, the servers count becomes short or excessive in some cases. When it is desired to avoid such a situation as a short servers count, it is required to always operate an excessive number of servers. As a result, there takes place such a situation that a power saving effect cannot be optimumly controlled.

In the prior art techniques, there is proposed such a static load concentration means as to restrict the number of servers in operation based on the load level at a certain time point when the system cannot predict an increase or decrease in the number of accesses from clients. However, in the prior art techniques, such control (which will be referred to as dynamic control, hereinafter) as to positively allocate a load to specific server and to create a load concentration state, is not disclosed. As a result, the prior art techniques cannot optimumly control the number of servers in operation to be increased or decreased for the power saving.

When performing simple dynamic load concentration, the prior art technique cannot maintain the service quality of a single server system at a level equal to or higher than a constant value.

It is therefore an object of the present invention to provide a load distribution system which can perform dynamic control and can exhibit a maximum power saving effect while maintaining the level of service quality required by users.

The above object and other objects of the present invention and novel features thereof will become apparent from the description of the present specification in conjunction with the attached drawings.

Typical ones of disclosed embodiments of the present invention will be summarized and briefly explained as follows.

That is, in the summary of one of the typical embodiments, a load distribution system has a threshold with respect to a processing state of the requests to maintain the sufficient service levels of a plurality of servers at predetermined values. When the client requests are allocated to the plurality of servers, the load distribution system allocates the requests to the server having higher priority until the processing state of the server reaches the threshold, and controls the powers of the plurality of servers according to the processing states of the plurality of servers with respect to their requests.

The other typical embodiment of the present invention disclosed in the present specification will be summarized and the effect thereof will be briefly explained as follow.

That is, the effect of the typical embodiment is to obtain a maximum power saving while maintaining the quality of services required by users at a constant level.

Other objects, features and advantages of the invention will become apparent from the following description of the embodiments of the invention taken in conjunction with the accompanying drawings.

### BRIEF DESCRIPTION OF THE DRAWINGS

FIG. 1 shows a configuration of a network system to which a load distribution system in accordance with a first embodiment of the present invention is applied;

FIG. 2 shows a detailed arrangement of the network system to which the load distribution system in accordance with the first embodiment of the present invention is applied;

FIG. 3A shows an information table of the load distribution system in accordance with the first embodiment of the present invention;

FIG. 3B shows an example of an allocation table of the load distribution system.

FIG. 4 shows an example of an algorithm of the load distribution system in accordance with the first embodiment of the invention;

FIGS. 5A, 5B and 5C are diagrams for explaining the basic concept of a load concentration mode of the load distribution system in accordance with the first embodiment of the invention;

FIG. 6 is a flow chart showing the processing operation of the load concentration mode in a transmission destination determiner of the load distribution system in accordance with the first embodiment of the invention;

FIG. 7 is a flow chart showing the processing operation of a load concentration mode (round robin mode) in the transmission destination determiner of the load distribution system in accordance with the first embodiment of the invention;

FIG. 8A is an information table for explaining the operation of the load concentration mode (round robin mode) of the load distribution system in accordance with the first embodiment of the invention;

FIG. 8B shows an example of an allocation table;

FIG. 9 is a flow chart showing the processing operation of the load concentration mode (round robin mode) in the transmission destination determiner of the load distribution system in accordance with the first embodiment of the invention;

FIG. 10 shows an example of the information table of the load concentration mode (round robin mode) of the load distribution system in accordance with the first embodiment of the invention;

FIGS. 11A and 11B are diagrams for explaining the effect of the load distribution system in accordance with the first embodiment of the invention; and

FIG. 12 shows a configuration of a load distribution system in accordance with a second embodiment of the present invention.

### DESCRIPTION OF THE EMBODIMENTS

Embodiments of the present invention will be explained in detail in connection with the attached drawings. In all the drawings for explanation of the embodiments, constituent elements having basically the same functions are denoted by the same reference numerals and explanation thereof is omitted to avoid double explanation.

### First Embodiment

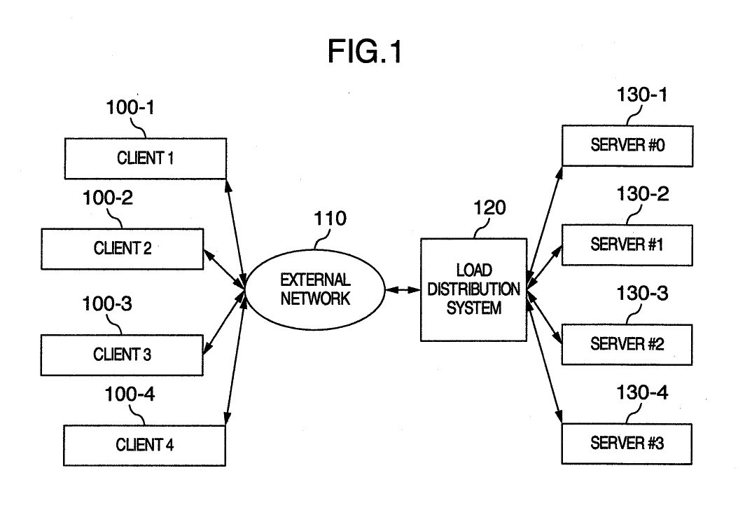

Explanation will be made as to a configuration of a network system to which a load distribution system in accordance with a first embodiment of the present invention is applied, by referring to FIG. 1. FIG. 1 shows a configuration of a network system to which a load distribution system in accordance with the first embodiment of the present invention is applied.

In the network system of FIG. 1, a server system including a plurality of servers 130-1 to 130-4 are connected to an external network 110 via a load distribution system 120.

For transfer of data packets between the server system and a client 100 connected to the external network 110, the load distribution system 120 is always interposed therebetween.

In an example of FIG. 1, 4 clients and 4 servers are illustrated, but the invention is not limited to the specific number and another number may be employed as a matter of course.

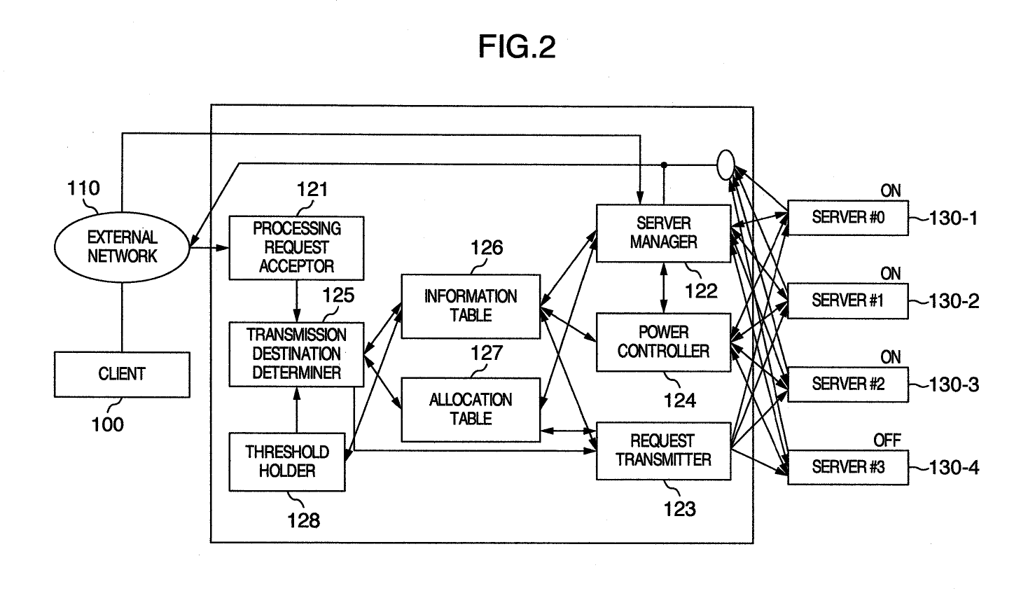

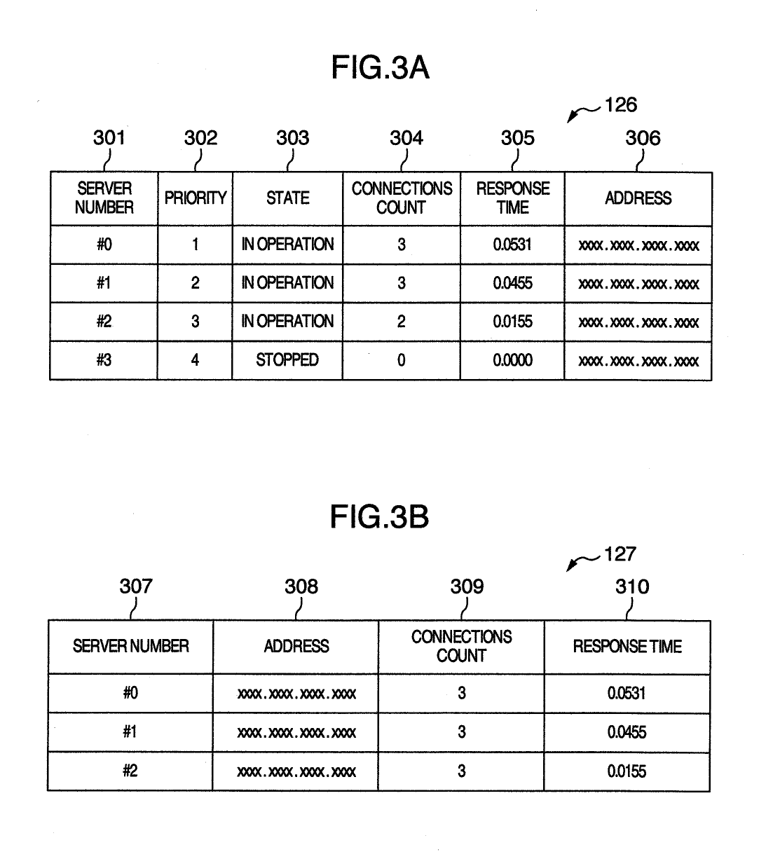

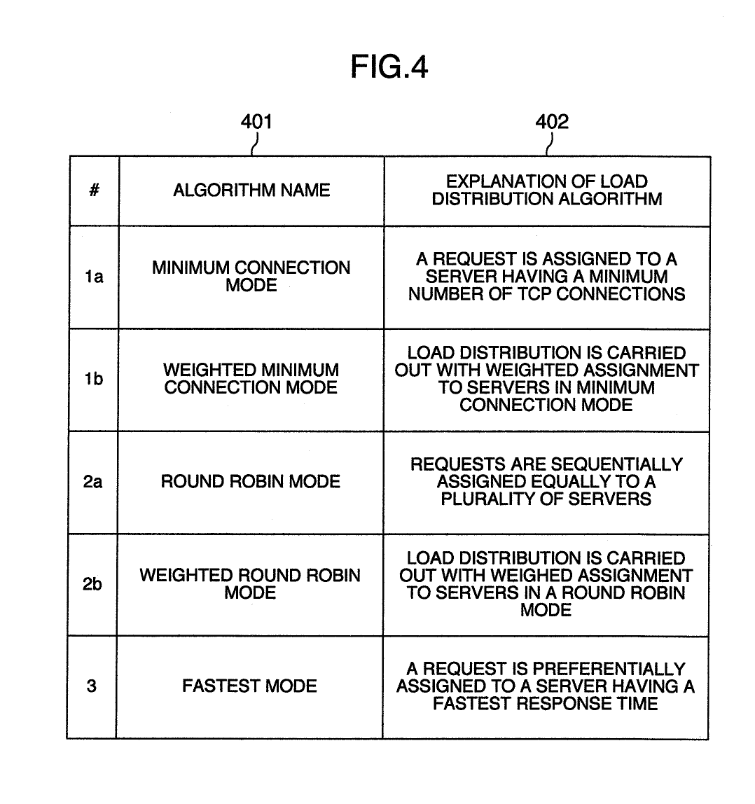

Explanation will then be made as to a configuration of the load distribution system in accordance with the embodiment of the invention, by referring to FIGS. 2, 3A, 3B, and 4. FIG. 2 shows an arrangement of the load distribution system in accordance with the first embodiment of the present invention, FIG. 3A shows an example of an information table of the load distribution system in accordance with the first embodiment of the invention, FIG. 3B shows an example of an allocation table of the load distribution system, and FIG. 4 shows an example of an algorithm of the load distribution system of the first embodiment.

In FIG. 2, the load distribution system 120 includes a processing request acceptor 121, a power controller 124, a server manager 122 as a means for managing the power controller 124, a request transmitter 123, a transmission destination determiner 125, an information table 126 having operational states and priorities of all servers in the server systems, an allocation table 127 having addresses of servers to which the load distribution system can allocate loads, and a threshold holder 128 having a threshold (which will be referred to as an assessment level, hereinafter) to maintain service level agreement.

When an event takes place, information is read out from the information table 126. The contents of the information table 126 is also modified every time when the state of a server is modified.

FIG. 3A shows a structure of the information table 126 and FIG. 3B shows a structure of the allocation table 127.

The assessment level can be arbitrarily set, and the settable contents of the assessment level include a connections count, a CPU usage percentage, an IO usage percentage, and a response time.

The processing request acceptor 121 accepts a data request packet from the client 100. The accepted request packet is sent to the transmission destination determiner 125, which in turn selects a transmission destination server for the packet and instructs the request transmitter 123 to send the request to the corresponding server.

After the request transmitter 123 successfully transmits the request to the address of the allocation table 127 instructed by the transmission destination determiner 125, the information table 126 is updated.

The method of selecting the transmission destination server has two modes, that is, a load distribution mode in which the transmission destination server is selected according to the conventional load distribution scheme using a load distribution algorithm, and a load concentration mode in which loads are assigned to and concentrated on a specific server by converting a load distribution algorithm to a load concentration type. The transmission destination server selection may be controlled according to any of the algorithms.

FIG. 4 shows a list of algorithms generalized by referring to the load distribution algorithm of the existing load distributor.

The server manager 122 monitors and manages the information table 126, the allocation table 127, and the server system 130-1 to 130-4.

For example, the server manager examines the processing quantity of each of the servers 130-1 to 130-4 of the server system in operation in a predetermined period of time. When determining that a server not used is present and the server meets power stop requirements, the server manager instructs the power controller to stop the power of the corresponding server, and instructs the information table 126 to update the contents of the information table to “stopped” in the corresponding part of the table.

Conversely, when the load level of all the servers 130-1 to 130-4 of the server system in operation exceeds an allowable level in the above predetermined time period and that power start requirements are satisfied, the server manager instructs the power controller to start a necessary number of waiting servers in the server system in order of priority of the waiting servers.

And the state of the started server in the information table 126 is updated to “being started”. After confirming the normal start of the server, the server manager adds the server in the allocation table 127 and when the server becomes allocable, updates the contents of the information table to “being started”.

The following power control scheme is also possible. When the embodiment is in the load concentration mode, a load is unequally distributed to the server having higher priority. Thus, the server the power of which is stopped next is the server having the lowest priority in the servers in operation. When determining that the server is not used and meets the power stop requirements judging from the load level of the server, the server manager excludes the server from the load allocation target, instructs the power controller to stop the power of the excluded server, confirms the stopped state of the power of the excluded server, and then updates the contents of the information table 126 to “stopped”.

The server manager 122 can also prevent the power starting and stopping operation from being concentrated on a specific server, for example, by modifying the priorities of waiting servers in the server system 130-1 to 130-4.

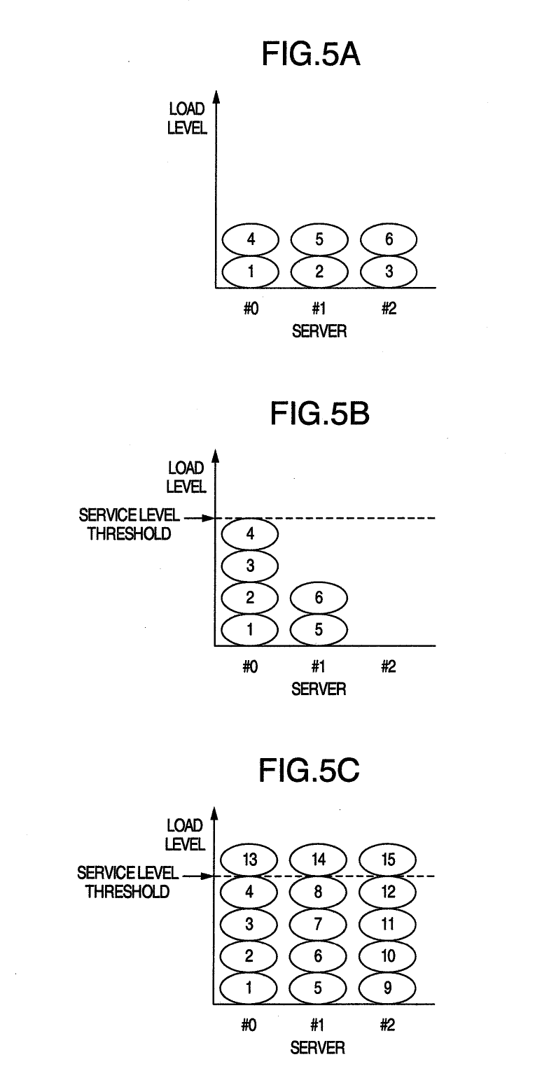

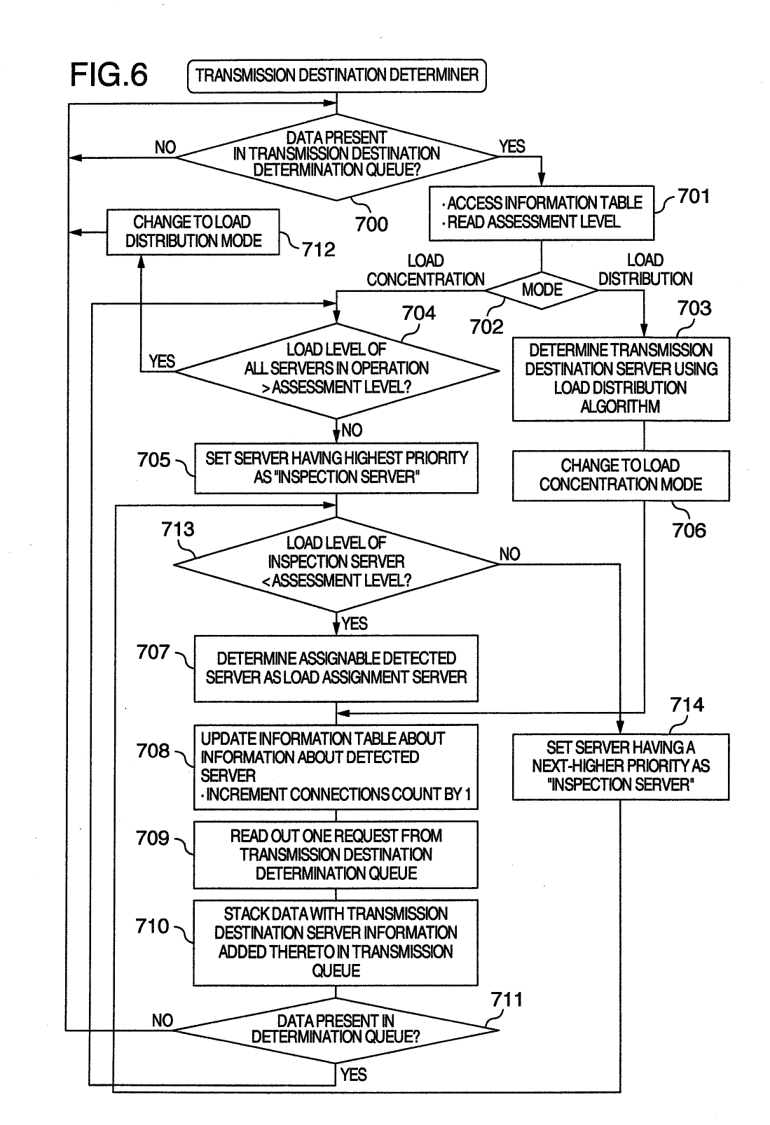

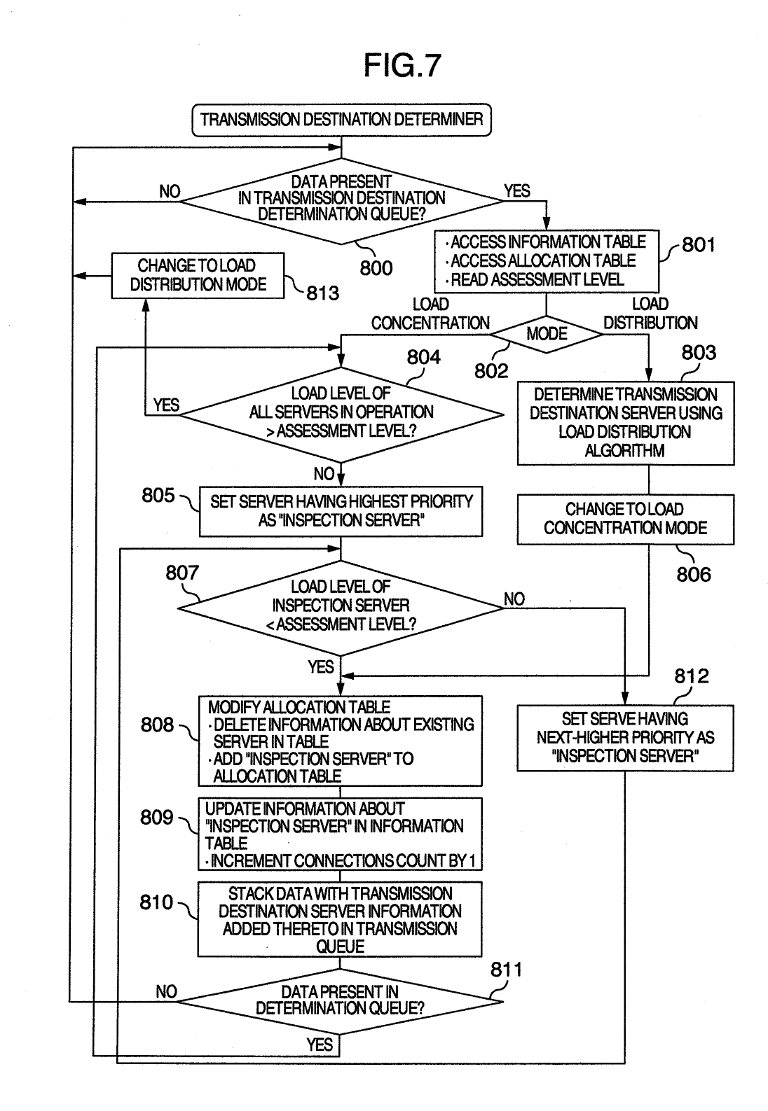

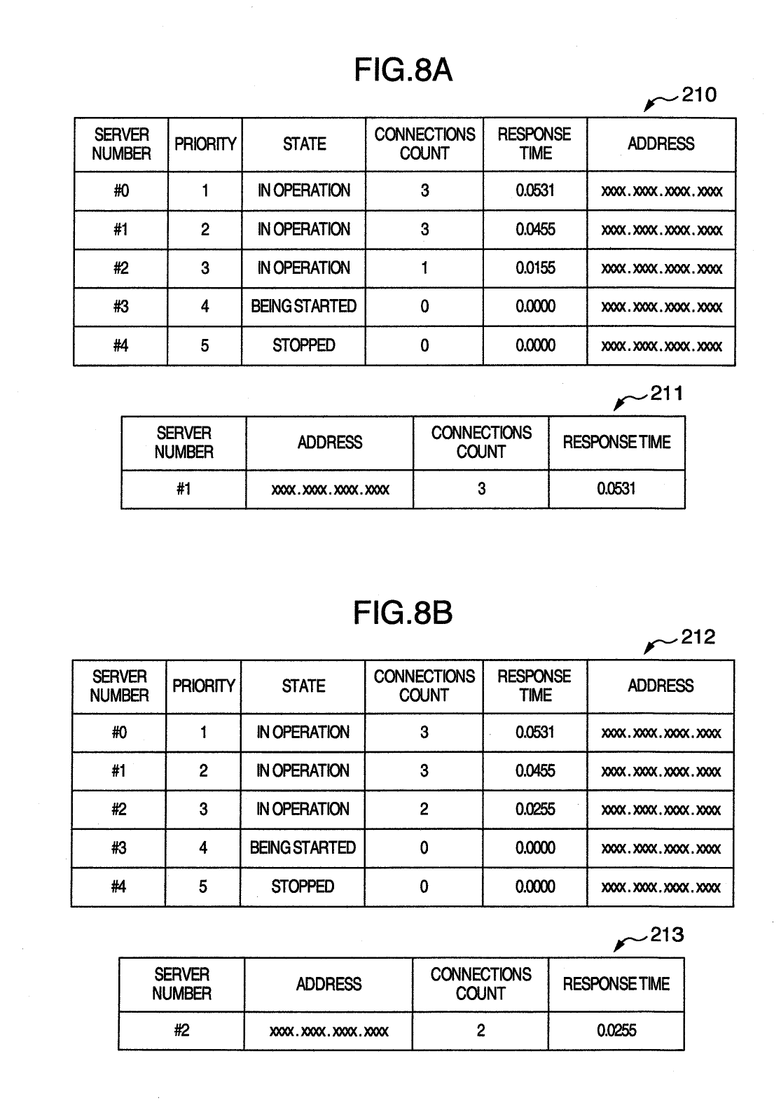

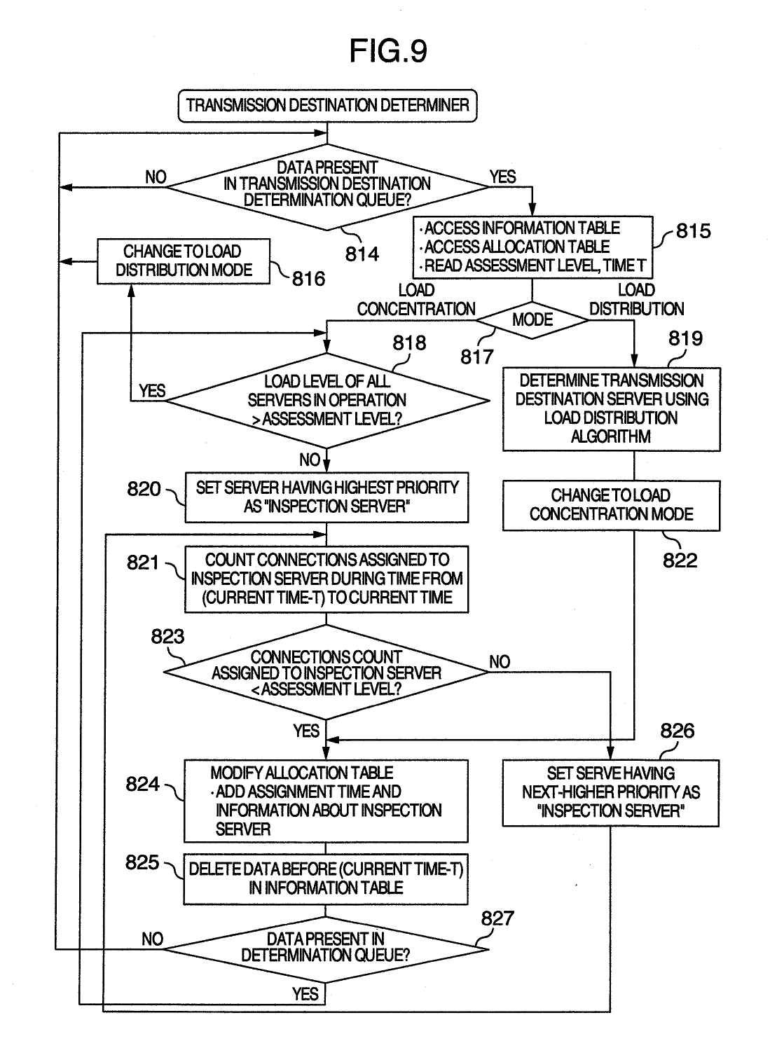

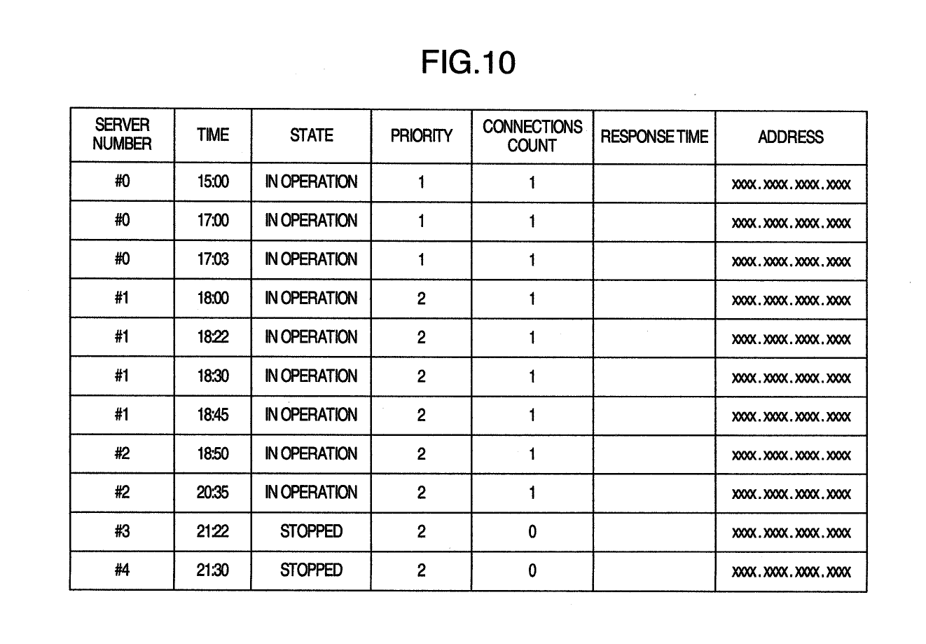

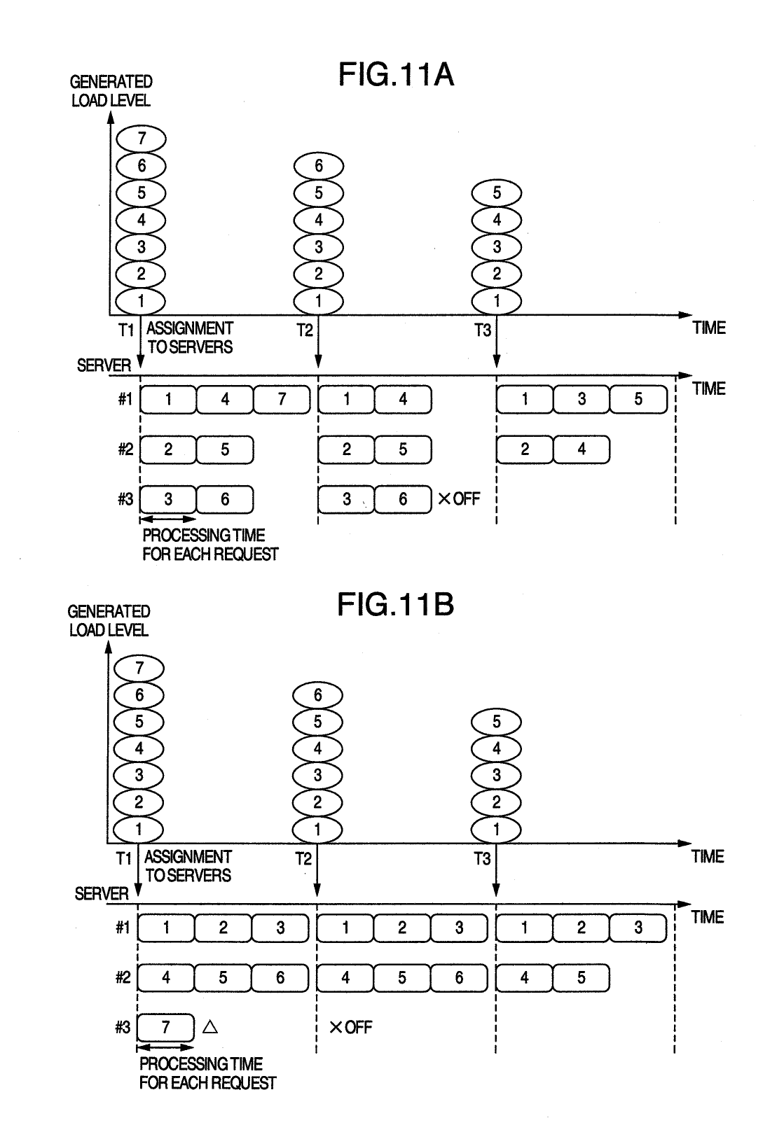

Explanation will next be made as to the operation of a load concentration mode of the transmission destination determiner in the load distribution system of the first embodiment of the invention, by referring to FIGS. 5 to 11. FIGS. 5A, 5B, and 5C are diagrams for explaining the basic concept of the load concentration mode of the load distribution system of the first embodiment; FIG. 6 is a flow chart showing the processing operation of the load concentration mode in the transmission destination determiner of the load distribution system of the first embodiment, FIGS. 7 and 9 are flow charts showing the processing operation of the load concentration mode (round robin mode) in the transmission destination determiner of the load distribution system of the first embodiment, FIGS. 8A and 8B show an example of the information table and an example of the allocation table for explaining the operation of the load concentration mode (round robin mode) of the load distribution system of the first embodiment respectively, FIG. 10 shows an example of the information table in the load concentration mode (round robin mode) of the load distribution system of the first embodiment, and FIGS. 11A and 11B are diagrams for explaining the effect of the load distribution system of the first embodiment.

A method of converting each of the load distribution algorithms shown in FIG. 4 to a load concentration type in the load concentration mode will first be explained by referring to FIG. 5 showing the basic concept of the load concentration mode and then by referring to FIGS. 6 to 9.

A difference between the conventional load distribution and the load concentration of the present embodiment is as follows.

In the conventional load distribution, a load is equally allocated to respective servers.

Assume for example that three servers are numbered by #0, #1 and #2, six equal loads which can be processed by any server are sequentially allocated. The loads 1 to 3 are sequentially distributed to three servers and the loads 4 to 6 are also sequentially distributed to the three servers. FIG. 5A shows how the loads 1 to 6 are allocated to all the servers and processed thereby.

In the load concentration mode of the present embodiment, on the other hand, priorities are provided to servers and loads are concentratedly allocated to servers having higher priorities.

In this case, when the loads are concentrated on specific one of the servers, its response time becomes long and its service quality drops. To avoid this, an assessment level is set to maintain a service quality prescribed by a service level agreement, the load is allocated to a specific server until the processing load level of the servers reaches this assessment level. After the load level reaches the assessment level, the other loads are allocated to the server having a next higher priority.

Assume, for example, that the assessment level is set in such a manner that up-to four loads per one server as its allowable range can be allocated and that three servers numbered by #0, #1 and #2 have first, second, and third priorities. Then when six loads which can be processed by any server are provided, the loads 1 to 4 are allocated to the server #0, the loads 5 and 6 are allocated to the server #1, and no load is allocated to the server #2 (refer to FIG. 5B).

In this condition, the power of the server #2 can be immediately stopped.

When the loads are further increased and the server system cannot maintain the assessment level (, which is not allowed originally from the viewpoint of system design, but it is necessary to previously assume such a situation), however, the load level already exceeds the load level assumed by the system design at this stage, and thus it is better to distribute the loads.

For example, when the loads cited in the above example are followed by additional loads, this means that the load level exceeds the assessment level. Since the assessment level cannot be kept at all for this increased load, it becomes necessary to change the current mode to the load distribution mode. Such a situation is explained by FIG. 5C. That is, each group of four of loads 1 to 12 is allocated to each one of the servers #0 to #2. The subsequent loads 13 to 15 are sequentially allocated to the servers #0 to #2 equally one load after another.

And it is assumed that, when the load level is decreased down to such a level as to be able to be maintained, the system returns to its primary load concentration mode.

The assessment level in this case can be arbitrarily set in the form of a connections count, a response time or the like desirable by a user.

Based on the basic concept of the load concentration mode, how to concentrate loads based on a load distribution algorithm will be explained in connection with examples of a minimum connection mode, a fastest mode, and a round robin mode.

In the minimum connection mode, first of all, there is considered a case where a load level in the basic concept of the load concentration mode is replaced with the connections count.

In the fastest mode, there is considered a case where, considering the latest response time (or an average of response times with respect to a plurality of latest requests) of each server, loads are allocated to the servers as far as the response time of a specific server is equal to or smaller than the assessment level. When the load level exceeds the assessment level, the loads are allocated to other servers.

A difference between the fastest mode and the minimum connection mode is whether the assessment level is the connections count or the response time.

Explanation will be made as to the above 2 modes by referring to a flow chart shown in FIG. 6.

It is assumed as a presupposition that, when there is a connection request from a new client, the request accepted by the request acceptor is stacked in a queue for transmission destination determination.

When there is data in the transmission destination determination queue (step 700), the transmission destination determiner reads out an assessment level from the threshold holder 128, accesses the information table 126 under the exclusive control to make the data reading/writing possible and reads information about the table (step 701).

When the load level of all servers in operation reaches the assessment level in the load concentration mode, the transmission destination determiner changes the load concentration mode to a load distribution mode (steps 702, 704, 712). In the load distribution method, the transmission destination determiner determines servers in such a manner that the loads are equally allocated to the servers according to the load distribution algorithm (steps 702 and 703). After the load distributing operation, the transmission destination determiner returns the mode to the load concentration mode (step 706). Since the load distribution algorithm used herein is a well known technique, detail explanation thereof is omitted.

When one of the servers in operation whose load level does not reach the assessment level is present, one of the serves having a highest priority is used as an “inspection server” (steps 704 and 705).

And the transmission destination determiner compares the load level of the “inspection server” with the assessment level (step 713). When the inspection server load level reaches the assessment level in the step 713, the transmission destination determiner uses one of the servers having a next-higher priority as the “inspection server” and checks whether or not the load level reaches the assessment level (step 714).

When the load level of the “inspection server” does not reach the assessment level in the step 713, the transmission destination determiner determines the inspection server as an allocation server (step 707), and updates a connections count column for the server in the information table 126 (step 708).

Comparison between the assessment level and the server load level at this time means, for example, when the assessment level is the connections count, comparison with the value of the connections count of the server, and, when the assessment level is the response time, means comparison with the value of the response time.

And the transmission destination determiner reads out a single piece of request information from the transmission destination determination queue, adds information about the transmission destination server to the read-out information, and stacks the added information in the transmission queue (steps 709 and 710).

The transmission destination determiner determines whether or not there is data in the determination queue (step 711). The presence of data in the determination queue causes the transmission destination determiner to return to the step 704. The absence of data in the determination queue in the step 711 causes the transmission destination determiner to return to the step 700.

The request transmitter 123 extracts and processes data stacked in the transmission queue. In the above case, the server not reaching the assessment level is assumed to be a state that, if one more load is newly allocated, the server does not reach or does just reach the assessment level, but the server does not exceed the assessment level (meet the service level agreement).

In order to satisfy this assumption, it is necessary to previously set the assessment level as follows. That is, how the service level varies with the load level allocated to the server is previously calculated on the basis of actually measured and theoretical values (, which requires the service level to simply decrease with an increase in the load level (monotonous decrease), otherwise which requires a quantitative unit set initially as the load level to be reconsidered). And such a maximum load level as to satisfy the service level agreement when a single load is newly allocated to the server, is required to be set as the assessment level.

When an increase or decrease in the load level varies with a single load for example, the assessment level is required to be such a maximum load level as to satisfy the service level agreement even when another one load having a maximum load level is newly allocated to a server. In more considered case, an increase in the load level may be estimated from the contents of the load now being allocated and it may be determined whether or not the load level reaches the assessment level on the basis of the estimated value in the processing operation of FIG. 6.

Since the load distributor usually has the function of analyzing the processing request contents in many cases, the implementation of this embodiment can be accomplished relatively easily. In a more considered case, different assessment levels may be set for different servers. In the present invention, in the step (step 705 in FIG. 6) upstream of the step (step 713 in FIG. 6) of determining whether or not the load level reaches the assessment level, the inspection server (that is, allocation destination server) is already determined. Thus such a case can be implemented.

Explanation will then be made as to the round robin mode by referring to flow charts of FIGS. 7 and 9.

In the conventional round robin mode, load distribution can be attained by sequentially allocating loads equally to a plurality of servers. However, it is difficult to convert the load distribution mode to the load concentration mode with this concept. For the round robin mode, two ideas are assumed to be taken as follows.

In one of the ideas of the round robin mode, when a load takes place, the load is simply allocated to a server having a priority next higher than the priority of the previous-time allocated server. In this case, if only one allocation destination is present, then the load is allocated only to the server.

In the present embodiment, the above idea is implemented in such a manner as to be explained below.

“It is assumed that there is only one specific server as an allocation destination among a plurality of present servers in operation. The allocation destination is used as the specific server until the load level reaches the assessment level. And when the load level reaches the assessment level, the allocation destination is a server having a priority next higher than the priority of the previously-allocated server.”

The above operation is carried out as follows.

(1) When the load level already reaches the assessment level in all the servers in operation, the transmission destination determiner changes the current mode to the load distribution method (steps 800, 801, 802, 804, and 813), and allocates the load to the server having a priority next higher than the priority of the last-allocated server (steps 800, 801, 802, 803, and 806).

(2) When there is one of the servers in operation which fails to reach the assessment level, the transmission destination determiner specifies the server having the highest priority as an “inspection server” (steps 804 and 805).

(3) The transmission destination determiner confirms whether or not the load level of the inspection server reaches the assessment level (step 807).

(4) When the load level of the inspection server fails to reach the assessment level in the step 807, the transmission destination determiner determines the inspection server as an allocation server, modifies the allocation table and the information table, that is, deletes corresponding server information present in the allocation table and adds it to the allocation table of the inspection server (step 808), and adds the load level of the “inspection server” in the information table 126 (step 809).

(5) The transmission destination determiner stacks the data added by the information about the transmission destination server in the transmission queue (step 810), and determines the presence or absence of data in the queue (step 811). The presence of data in the queue in the step 811 causes the transmission destination determiner to return to the step 804. The absence of data in the queue in the step 811 causes the transmission destination determiner to return to the step 800.

(6) When the load level of the inspection server reaches the assessment level in the step 807, the transmission destination determiner regards the server having a next-higher priority as the inspection server and returns to the step 807 (step 812).

Assume for example that an assessment level is a connections count of 3 and one load takes place at the time when the information table and the allocation table have such conditions as shown in FIG. 8A. Then when the transmission destination determiner checks the connections count according to the priority order, the determiner determines that, among the servers in operation whose connections count is smaller than the assessment level, the server having a server number 2 has a highest priority, and thus determines the highest priority server as an allocation destination. To this end, the transmission destination determiner deletes information about the existing server in the allocation table and newly adds the target server therein, the information table and the allocation table are modified from such a state as shown in FIG. 8A to such a state as shown in FIG. 8B.

In the second idea of the round robin mode of load distribution, the number of loads to be allocated in a constant time period T is set to be equal among target servers. With such an idea, load concentration is implemented as follows.

“The number of loads to be allocated in a constant period of time is concentratedly directed to specific one of the target servers. However, the number of allocating loads is set to be not larger than the assessment level.”

That is, the above operation is carried out as follows.

(1) When the load level reaches the assessment level in all the servers in operation, the transmission destination determiner changes the current mode to the load distribution method (steps 814, 815, 816, 817 and 818), and allocates the load to the server having a priority next higher than the priority of the last-allocated server according to the load distribution algorithm (steps 814, 815, 817, 819, and 822).

(2) When there is one of the servers in operation which fails to reach the assessment level, the transmission destination determiner determines the server having the highest priority as an “inspection server” (steps 818 and 820).

(3) The transmission destination determiner counts the number of allocated connections of the inspection server during a period from (the current time—T) to the current time (step 821).

(4) The transmission destination determiner confirms whether or not the allocated connections count of the inspection server reaches the assessment level (step 823).

(5) If the allocated connections count of the inspection server fails to reach the assessment level in the step 823, then the transmission destination determiner determines to allocate the load to the server, modifies the allocation table, and adds its allocation time and information about the inspection server in the allocation table (step 824).

(6) The transmission destination determiner deletes data before (the current time—T) in the information table (step 825), and determines whether or not there is data in the determination queue (step 827). If there is data in the queue in the step 827, then the transmission destination determiner returns to the step 818. If there is no data in the queue in the step 827, then the transmission destination determiner returns to the step 814.

(7) When the allocated connections count of the inspection server reaches the assessment level in the step 823, the transmission destination determiner determines the server having a next-higher priority as the inspection server and returns to the step 821 (step 826).

The information table records therein past-allocated servers and their allocated times, for example, as shown in FIG. 10, so that the number of allocated connections can be calculated in a constant period of time (such as 1 second, 10 seconds, one minute or one hour, which are selected by the user according to his used application). That is, the transmission destination determiner determines whether or not the number of connections of the inspection server is not larger than the assessment level in the step 823.

Next, explanation will be made as to the effect of the load distribution system of the present embodiment.

As a comparison example, first, the operation of power saving control in the prior art will be shown in FIG. 11A.

It is assumed that there are three servers operating in the server system and each server can process up-to three loads (which means that the assessment level is set to be a load level of three). In the prior art, an equal number of loads are allocated to each of servers. Thus, when seven loads take place at a time point T1 and servers are processing the loads as an example, the loads are equally allocated to the servers at the time T1. More specifically, in FIG. 11A, three loads are allocated to the server #1, two loads are to the server #2, and two loads to the server #3.

When six loads take place at a time point T2 and five loads take place at a time point T3, six loads can be processed by two servers, so that such loads can be simply considered to be processed by two servers, meaning that the powers of two servers can be turned off at this time point.

In the load distribution, however, the loads are once allocated equally to the three servers. For example, each two of the six loads occurred at the time point T2 are allocated to each of the servers, so that at least at a time point after any of the servers finishes processing the two loads, the power of the server can be stopped.

As in the present embodiment, on the other hand, load concentration is carried out. That is, loads are allocated to a specific server until the load level reaches the assessment level, and, when the load level reaches the assessment level, the loads are allocated to the next server. More specifically, as shown in FIG. 11B, seven loads occurred at the time T1 are allocated to the severs sequentially from #1 until the load level reaches the assessment level, so that three loads are allocated to the server #1, three loads are to the server #2, and one load is to the server #3.

Since six loads occurred later at the time T2 can be processed by the two serves, no load is allocated to the server #3. Thus the power of the server #3 can be turned off before the time T2 (or at a time point A earlier than the T2 in some cases).

From simple models shown in FIGS. 11A and 11B, it will be seen that the degree of the effect of the present embodiment based on the power saving control depends upon the length of load processing time. For example, in the prior art, the power of the server can be stopped only after the server finishes processing its load. In the prior art, in other words, equal load allocation is carried out to the power stop server, the number of loads allocated to the server is larger than in the present embodiment. That is, in the prior art, the longer the load processing time the longer the time until power stoppage is.

Therefore, when the server is connected to the Internet continuously for a considerably long time duration upon once connected as when the server is used for internet shopping or for distribution of streaming data in the Internet, the effect of the load concentration operation of the present embodiment becomes great.

### Second Embodiment

In the first embodiment, the load distribution system 120 has functions of the server manager 122, transmission destination determiner 125, power controller 124, information table 126, allocation table 127 and threshold holder 128. In the second embodiment, on the other hand, such functions are installed into a management server for managing a plurality of load distributors.

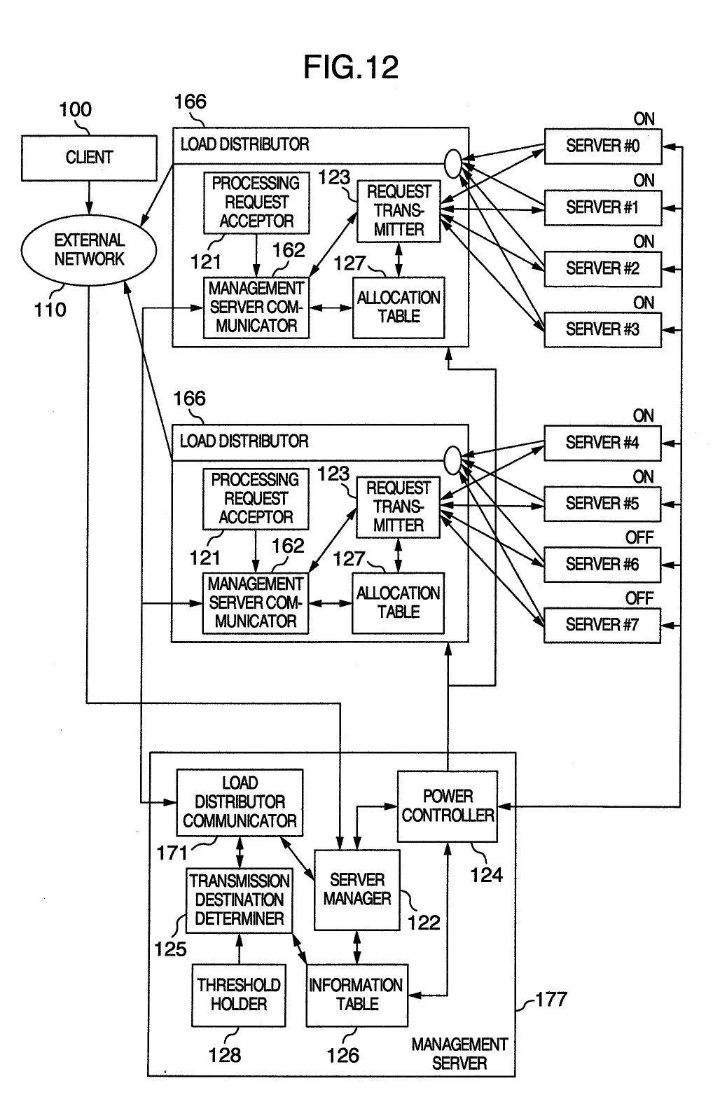

Explanation will be made as to a configuration of a load distribution system in accordance with the second embodiment of the invention, with reference to FIG. 12. FIG. 12 shows a configuration of a load distribution system in accordance with the second embodiment of the invention.

In FIG. 12, the load distribution system includes two load distributors 166 each connected to a server system having four servers, and also includes a management server 177 for managing the load distributors 166.

The load distributor 166 includes a processing request acceptor 121, a management server communicator 162 for communicating with the management server 177, a request transmitter 123 for transmitting a load to a server in response to an instruction from the management server 177, and a allocation table 127 having information about allocation destination servers.

The management server 177 includes a load distributor communicator 171 for communicating with the load distributors 166, a transmission destination determiner 125 for determining the distribution destination of a processing request accepted at the load distributor 166, a server manager 122 for monitoring and managing all the servers, a power controller 124 for controlling the power of computers, an information table 126 having information about the respective servers and information about the load distributors 166, and a threshold holder 128 having an assessment level.

The general operation of the load distribution system of the present embodiment is similar to the operation of the first embodiment.

In the present embodiment, in this way, the management server 177 has functions of the server manager 122, transmission destination determiner 125, power controller 124, information table 126, allocation table 127, and threshold holder 128, independently of the load distributor 166; the management server 177 can control a plurality of the load distributors 166 and also can control the server systems connected to the plurality of the load distributors 166, thereby achieving a more efficient power saving effect.

Although two of the load distributors 166 are provided as targets to be controlled by the management server 177 in the example of FIG. 12, the number of such load distributors are not limited to two, but any number of such load distributors may be employed.

In this case, load concentration can be attained across the plurality of load distributors 166. In the example of FIG. 12, in other words, when loads can be processed only by the server systems connected to a single load distributor 166, the power of the server systems to which the loads are not allocated can be stopped together with the power of the associated load distributor 166.

The invention made by inventors of the present application has been explained in detail in connection with the embodiments. However, the present invention is not limited to the above embodiments, but may be modified in various ways without departing from the spirit and scope of the invention.

For example, in the first and second embodiments, the server systems as allocation destinations of requests from clients are not limited to physical servers, but may be virtual servers.

The present invention, which is directed to a load distribution system in an information processing system or the like, can be widely applied to a system which requires its general power saving together with load distribution.

It should be further understood by those skilled in the art that although the foregoing description has been made on embodiments of the invention, the invention is not limited thereto and various changes and modifications may be made without departing from the spirit of the invention and the scope of the appended claims.

1. A load assignment control method in a load distribution system for assigning a plurality of requests from a plurality of clients to a plurality of servers,
by the load distribution system,
holding a threshold with respect to a processing state of the requests to maintain respective service levels of the plurality of servers;
assigning the requests to a server having a higher priority until the processing state of the server reaches the threshold and after that assigning the requests to the server having a next higher priority; and
controlling powers of the plurality of servers according to the processing states of the plurality of servers for the requests.

2. A load assignment control method according to claim 1, wherein, upon assignment of the request to the plurality of servers, the load distribution system distributes the requests equally to the plurality of servers when all the processing states of the plurality of servers reach the threshold.

3. A load assignment control method according to claim 1, wherein the load distribution system, when confirming that one of the plurality of servers in operation having a lowest priority is not in its processing operation state, excludes the lowest priority server from load assignment targets.

4. A load assignment control method according to claim 1, wherein the processing state of the server is determined by a connections count, a response time, or a processing quantity within a predetermined time period.

5. A load distribution system for assigning a plurality of requests from a plurality of clients to a plurality of servers comprising:
an information table including a priority, a connections count, a response time, an assignment time and a state for each of the plurality of servers;
a threshold holder having a threshold with respect to a processing state of the requests to maintain service levels of the plurality of servers;
a server manager for monitoring and managing the operational states of the plurality of servers;
a transmission destination determiner for assigning the requests to a server having a higher priority until the processing state of the server reaches the threshold and after that assigning the requests to the server having a next higher priority; and
a power controller for controlling powers of the plurality of servers according to the processing states of the plurality of servers for the requests.

6. A load distribution system according to claim 5, wherein, upon assignment of the requests to the plurality of servers, the transmission destination determiner distributes the requests equally to the plurality of servers when all the processing states of the plurality of servers reach the threshold.

7. A load distribution system for assigning a plurality of requests from a plurality of clients to a plurality of servers, comprising:
a plurality of load distributors; and
a management server for managing the plurality of load distributors,
wherein the management server includes:
an information table including priorities, connections counts, response times, assignment times and states for the plurality of servers;
a threshold holder for holding a threshold with respect to a processing state of the requests to maintain service levels of the plurality of servers;
a server manager for monitoring and managing operational states of the plurality of servers;
a transmission destination determiner for assigning the requests to a server having a higher priority until the processing state of the server reaches the threshold and after that assigning the requests to the server having a next higher priority;
a power controller for controlling powers of the plurality of servers according to processing states of the plurality of servers for the request; and
a load distributor communicator for instructing the plurality of load distributors to cause the transmission destination determiner to assign the requests.

8. A load distribution system according to claim 7, wherein, when powers of all servers connected to specific one of the plurality of load distributors can be stopped, the power controller stops a power of the specific load distributor under power control of the plurality of servers.
